(19) United States
(12) Patent Application Publication
(10) Pub. No.: US 2012/0299359 A1
(43) Pub. Date: Nov. 29, 2012

(54) VEHICLE SEAT

(75) Inventor: Hideyuki ABE, Toyota-shi (JP)

(73) Assignee: TOYOTA BOSHOKU KABUSHIKI KAISHA, Aichi-ken (JP)

(21) Appl. No.: 13/477,518

(22) Filed: May 22, 2012

(30) Foreign Application Priority Data
May 25, 2011 (JP) 2011-116892

(51) Int. Cl. B60N 2/50

(52) U.S. Cl. 297/452.56

(57) ABSTRACT

There is provided a vehicle seat which includes a pad support which includes a net for supporting a cushion pad, and a wire harness which is wired while being hung on the net via a clip attached to the net in a state of not causing a foreign-body feeling to a seated person.

### BACKGROUND OF THE INVENTION

1. Field of the Invention

The present invention relates to a vehicle seat. More specifically, the present invention relates to a vehicle seat including a pad support having a net for supporting a cushion pad and a wire harness wired therein.

2. Description of the Related Art

Conventionally, there has been known a front seat 501 which includes a pad support 530 for preventing a cushion pad 520 of a seat cushion 502 from being sunk down. For example, JP-A-2010-125121 suggests, as shown in FIGS. 8 and 9, a front seat in which the pad support 530 is configured by a plurality of S-shaped springs 534. Thereby, the wire harness W can be hung on the S-shaped springs 534 via a resin attachment member 540 and thus the wire harness W can be wired in the seat cushion 502 without causing a foreign-body feeling to a seated person.

In the technique like suggested in JP-A-2010-125121, for example, in order to reduce weight of the seat and secure a space below the seat cushion 502, it is necessary to make a thickness of the cushion pad 520 of the seat cushion 502 thinner. However, as the thickness of the cushion pad 520 is made thinner, there is a problem that the S-shaped springs 534 cause a foreign-body feeling to the seated person. In order to solve this problem, there has been proposed a technique using a stretched net instead of the S-shaped springs 534. However, in this technique, another problem occurs that an attachment member for hanging the wire harness W on the stretched net causes a foreign-body feeling to the seated person when the wire harness W is wired in the stretched net.

### SUMMARY OF THE INVENTION

The present invention has been made in view of the above circumstances, and an object of the present invention is to provide a vehicle seat capable of wiring a wire harness on a stretched net without causing a foreign-body feeling to a seated person.

According to an illustrative embodiment of the present invention, there is provided a vehicle seat comprising: a pad support which includes a net for supporting a cushion pad; and a wire harness which is wired while being hung on the net via a clip attached to the net in a state of not causing a foreign-body feeling to a seated person.

According to this configuration, although the net is used, the wire harness can be wired. At this time, since the clip is attached to the net in a state of not causing a foreign-body feeling to a seated person, there occurs no problem which causes the foreign-body feeling to the seated person.

According to the above vehicle seat, the pad support may further include a wire formed in a substantially rectangular shape, the net may be stretched over the wire to have an extra length part, and the wire harness may be wired while being hung on the extra length part of the net.

According to this configuration, since the clip is attached to the extra length part of the net, it is possible to securely prevent the foreign-body feeling from being caused to the seated person.

According to another illustrative embodiment of the present invention, there is provided a vehicle seat comprising: a pad support which includes a wire formed in a substantially rectangular shape and a net for supporting a cushion pad, the net including a stretched portion which is stretched over the wire in a stretched state, and an extra length part which extends from the stretched portion; and a wire harness which is wired while being hung on the extra length part of the net via a clip.

### BRIEF DESCRIPTION OF THE DRAWINGS

The above and other aspects of the present invention will become more apparent and more readily appreciated from the following description of illustrative embodiments of the present invention taken in conjunction with the attached drawings, in which:

FIG. 1 is an exploded perspective view showing a seat cushion of a vehicle seat according to an illustrative embodiment 1 of the present invention;

FIG. 2 is a perspective view showing a pad support of FIG. 1 as viewed from a lower side;

FIG. 3 is a sectional view taken along line III-III of FIG. 2 and shows a longitudinal section of the pad support;

FIG. 4 is a view showing a longitudinal section of a pad support according to an illustrative embodiment 2 of the present invention;

FIG. 5 is a view showing a longitudinal section of a pad support according to an illustrative embodiment 3 of the present invention;

FIG. 6 is a view showing a longitudinal section of a pad support according to an illustrative embodiment 4 of the present invention;

FIG. 7 is a view showing a longitudinal section of a pad support according to an illustrative embodiment 5 of the present invention;

FIG. 8 is an exploded perspective view showing a seat cushion of a related-art vehicle seat; and

FIG. 9 is a perspective view showing a pad support of FIG. 8 as viewed from the lower side.

### DETAILED DESCRIPTION

Hereinafter, illustrative embodiments of the present invention will be described with reference to the accompanying drawings.

### Illustrative Embodiment 1

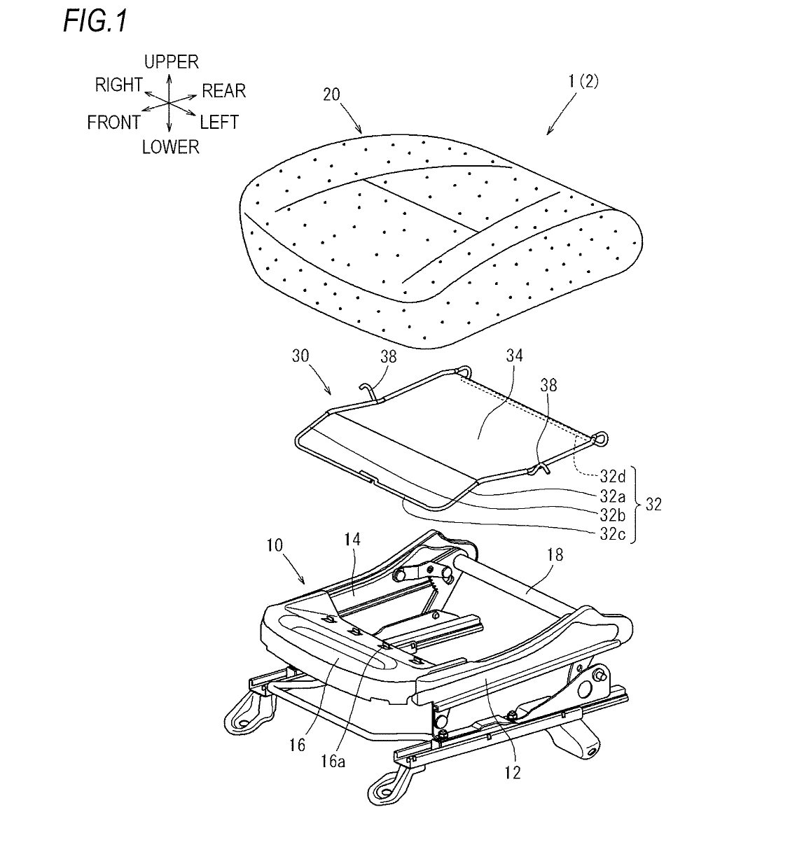

First, an illustrative embodiment 1 of the present invention will be described by referring to FIGS. 1 to 3. In the following description, a front seat 1 (for example, a driver's seat or a passenger seat) will be described as an example of a vehicle seat. Further, in the following description, upper, lower, front, rear, left and right directions respectively correspond to upper, lower, front, rear, left and right directions shown in the accompanying drawings, and refer to the upper, lower, front, rear, left and right directions on a basis of the front seat 1. This is similarly applied to all illustrative embodiments described later.

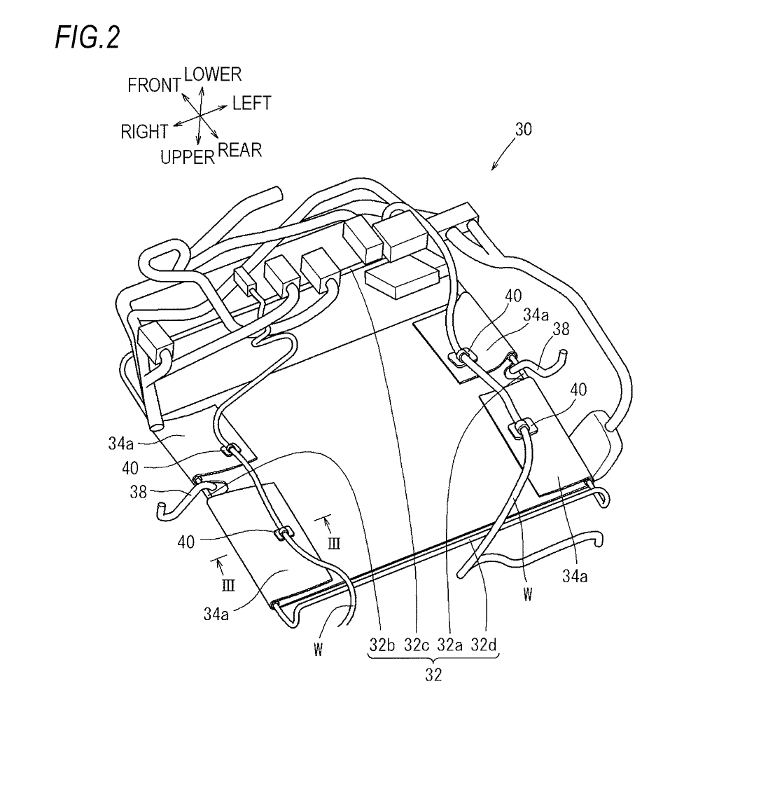

First, an overall configuration of the front seat 1 according to the illustrative embodiment 1 of the present invention will be described by referring to FIGS. 1 and 2. The front seat 1 mainly includes a seat cushion 2 and a seat back (not shown). Hereinafter, a detailed configuration of the seat cushion 2 will be described. The seat back (not shown) may have a conventional configuration and thus a detailed description thereof will be omitted.

The seat cushion 2 includes a cushion frame 10, a cushion pad 20 which is assembled to cover the cushion frame 10, a pad support 30 for preventing the assembled cushion pad 20 from being sunk down and an outer skin (not shown) for covering the surface of the cushion 20.

The cushion frame 10 includes a left side frame 12, a right side frame 14, a front panel 16 and a rear rod 18. The left side frame 12, the right side frame 14, the front panel 16 and the rear rod 18 are joined by a welding to form a substantially rectangular frame shape.

Meanwhile, the pad support 30 includes a wire 32 and a net 34. The wire 32 has a left side wire 32a, a right side wire 32b, a front side wire 32c and a rear side wire 32d to form a substantially rectangular frame shape. The net 34 is stretched over the wire 32. That is, the net 34 spreads within the wire 32. The left and right side wires 32a, 32b of the wire 32 are formed with hooks 38, 38 which can be hung on the left and right side frames 12, 14 of the cushion frame 10.

Further, the front side wire 32c of the wire 32 is formed to be hung on cut-raised pieces 16a which are provided in the front panel 16 of the cushion frame 10. Further, the rear side wire 32d of the wire 32 has side end portions which are bent to be hung on the rear rod 18 of the cushion frame 10.

Herein, a method for providing a net 34 in a stretched state will be described in detail. First, the wire 32 is set in a lower mold (not shown) of a stretching device (not shown). Then, the net 34 is set on the set wire 32. The net 34 is formed with an extra length part 34a (not shown in FIG. 1) which has a sufficient length in a width direction of the wire 32.

The operation of setting the net 34 is performed in a state where the extra length part 34a is grasped such that net 34 is spread. Then, an upper mold (not shown) of the stretching device and the lower mold are clamped. Finally, a resin 36 (not shown in FIGS. 1 and 2) is injected to join the left and right side members 32a, 32b and the net 34. As the injected resin 36 is solidified, the wire 32 provided with the stretched net 34, that is, the pad support 30 is completed.

In the pad support 30 thus configured, as described above, hooks 38 of the left and right side wires 32a, 32b are hung on the left and right side frames 12, 14 of the cushion frame 10, the front side wire 32c is hung on the cut-raised pieces 16a of the front panel 16 of the cushion frame 10, and the rear side wire 32d is hung on the rear rod 18 of the cushion frame 10 and assembled to the cushion frame 10.

Thereafter, the cushion pad 20 is assembled to the cushion frame 10 provided with the pad support 30 and the surface of the assembled cushion pad 20 is covered with the outer skin (not shown). As a result, the seat cushion 2 is completed.

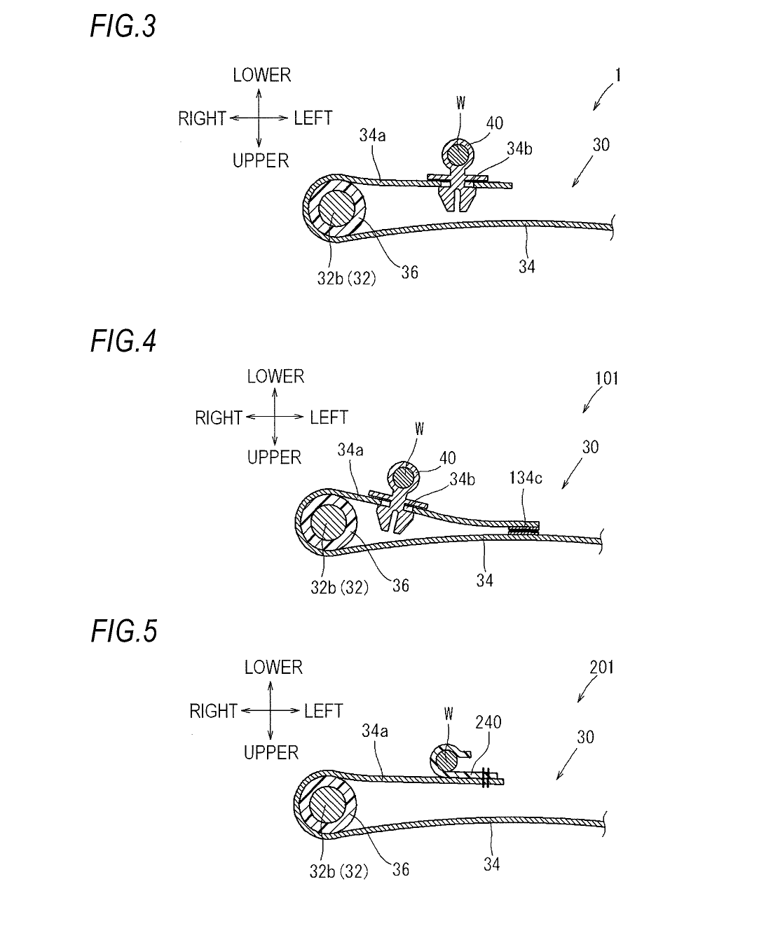

Next, a method for wiring a wire harness W in the seat cushion 2 will be described by referring to FIGS. 2 and 3. First, the wire harness W is inserted in a clip 40. FIG. 2 shows an example where each of two wire harnesses W, W is inserted in two clips 40, 40, respectively.

Subsequently, each clip 40 is inserted and engaged in (attached to) an insertion hole 34b (not shown in FIG. 2) formed at each extra length part 34a of the net 34. This state is an example of a state where the wire harness is hung on the net via a clip attached to the net in a state of not causing a foreign-body feeling to the seated person. As each clip 40 is engaged in this manner, the operation for wiring two wire harnesses W, W in the seat cushion 2 is completed.

The front seat 1 according to the illustrative embodiment 1 of the present invention is configured as described above. According to the above configurations, each of the wire harnesses W, W is inserted into the two clips 40, respectively, and then the clips 40 are inserted and engaged in the insertion holes 34b formed at each extra length part 34a of the net 34. Accordingly, the wire harness W can be wired even on the stretched net 34. At this time, since each clip 40 is engaged in each extra length part 34a of the net 34, a foreign-body feeling is not caused to a seated person.

Further, according to the above configurations, since each clip 40 is engaged in each extra length part 34a of the net 34, it is possible to securely avoid causing a foreign-body feeling to a seated person.

### Illustrative Embodiment 2

Next, an illustrative embodiment 2 of the present invention will be described by referring to FIG. 4. The front seat 101 of the illustrative embodiment 2 is improved in an appearance of the extra length part 34a of the net 34 in a state where the wire harness W is wired, as compared to the front seat 1 of the illustrative embodiment 1 described above. Meanwhile, in the following description, the same or similar element will be denoted by the same reference numeral as that of the illustrative embodiment 1, and the duplicated explanation thereof will be omitted. This is similarly applied to all illustrative embodiments described below.

Hook and loop fasteners (Velcro tapes: registered trademark) 134c are respectively sewn in an end of each extra length part 34a of the net 34 and each inner surface of the net 34 opposed to the end.

The front seat 101 according to the illustrative embodiment 2 of the present invention is configured as mentioned above. According to the configurations, the front seat 101 can achieve same effect as the front seat 1 of the illustrative embodiment 1. Further, according to the above configuration, since the hook and loop fasteners (Velcro tapes: registered trademark) 134c allows the end of the extra length part 34a to be attached to the inner (lower) surface of the net 34, it is possible to prevent the extra length part 34a from flapping from the net 34. Accordingly, it is possible to improve an appearance of the extra length part 34 of the net 34 in a state where the wire harness W is wired.

### Illustrative Embodiment 3

Next, an illustrative embodiment 3 of the present invention will be described by referring to FIG. 5. In the front seat 201 of the illustrative embodiment 3, the wire harness W is firmly hung on the net 34, as compared to the front seat 1 of the illustrative embodiment 1 described above.

J-shaped clips 240 are respectively sewn in an end (tip end) of each extra length part 34a of the net 34. Similar to the clip 40 described in the illustrative embodiment 1, a wire harness W is inserted into (hung on) each of the clips 240.

The front seat 201 according to the illustrative embodiment 3 of the present invention is configured as described above. According to the configurations, the front seat 201 can achieve same effect as the front seat 1 of the illustrative embodiment 1. Further, according to the above configuration, since each clip 240 is respectively sewn in each extra length part 34a, it is possible to securely prevent the clip 240 from being separated from the net 34, as compared to the clip 40 described in the illustrative embodiment 1. Accordingly, it is possible to allow the wire harness W to be firmly hung on the net 34.

### Illustrative Embodiment 4

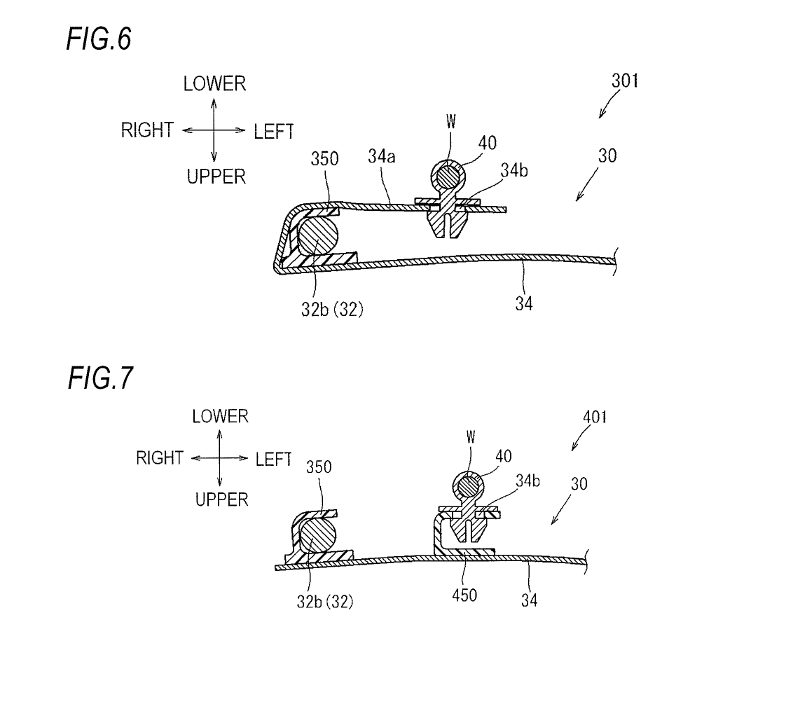

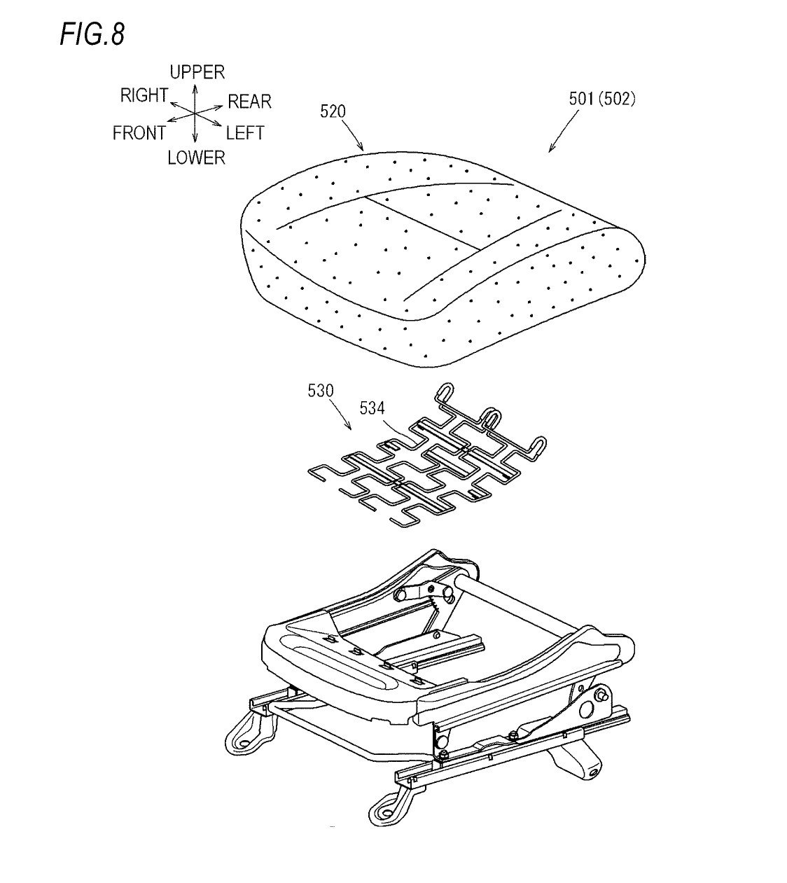

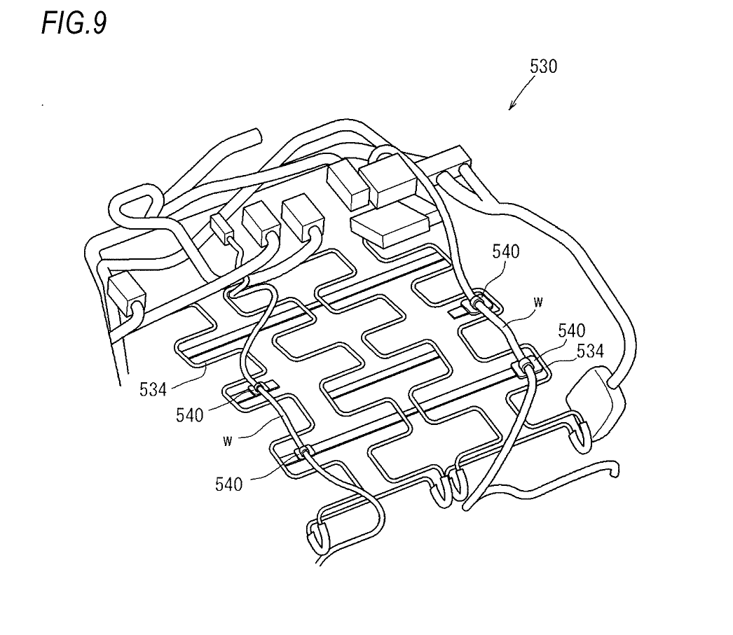

Next, an illustrative embodiment 4 of the present invention will be described by referring to FIG. 6. In the front seat 301 of the illustrative embodiment 4, the net 34 is more strongly stretched within the wire 32, as compared to the front seat 1 of the illustrative embodiment 1 described above.

Resin hooks 350 in which the left and right side wires 32a, 32b of the wire 32 can be hung are integrally molded in the net 34. The resin hook 350 is integrally molded at a position in which the net 34 is in a stretched state when the left and right side wires 32a, 32b of the wire 32 are hung on the resin hook.

The front seat 301 according to the illustrative embodiment 4 of the present invention is configured as described above. According to the configurations, the front seat 301 can achieve same effect as the front seat 1 of the illustrative embodiment 1. Further, according to the above configuration, since the resin hook 350 is integrally molded in the net 34, by causing the wire 32 to be hung in the resin hook 350, it is possible to prevent the wire 32 from being separated from the net. Accordingly, it is possible to securely fix the stretched net 32 in the wire 32.

### Illustrative Embodiment 5

Next, an illustrative embodiment 5 of the present invention will be described by referring to FIG. 7. In the front seat 401 of the illustrative embodiment 5, the wire harness W is firmly hung on the net 34, as compared to the front seat 301 of the illustrative embodiment 4 described above.

Similar to the resin hook 350, a resin bracket 450 is integrally molded on the net 34 at an inner side of the resin hook 350. Similarly to the illustrative embodiment 1, the clip 40 in which the wire harness W is inserted is inserted and engaged with the resin bracket 450.

The front seat 401 according to the illustrative embodiment 5 of the present invention is configured as mentioned above. According to the configurations, the front seat 401 can achieve same effect as the front seat 301 of the illustrative embodiment 4. Further, according to the above configuration, since the resin bracket 450 which causes the clip 40 to be further inserted and engaged therewith is integrally molded in the net 34, the clips 40 can be more securely engaged, as compared to the engagement by the clips 40 mentioned in the illustrative embodiment 4. Accordingly, it is possible to allow the wire harness W to be firmly hung in the net 34.

While the present invention has been shown and described with reference to certain illustrative embodiments thereof, it will be understood by those skilled in the art that various changes in form and details may be made therein without departing from the spirit and scope of the invention as defined by the appended claims.

For example, in each illustrative embodiment, the front seat 1 is described as an example of the vehicle seat. However, the present invention is not limited to the front seat and may be applied to a rear seat.

Further, in each illustrative embodiment, a case of wiring the wire harness Win the seat cushion 2 is explained. However, the present invention is not limited to this case and may be applied to a case where the wire harness is wired in the seat back.

Further, in the illustrative embodiments 1 to 4, a case where the clips 40, 240 are engaged in the extra length part 34a of the net 34 is described. However, the present invention is not limited to this case and may be applied to a case where an air conditioning fan (not shown) for blowing an air through a surface of the seat cushion 2 and/or the seat back is further provided in the extra length part 34a.

Further, in the illustrative embodiment 2, the wire harness W is inserted in the clip 40, the end of the extra length part 34a is adhered to the inner (lower) surface of the net 34 by the hook and loop fasteners (Velcro tapes: registered trademark) and the clip 40 is inserted in the extra length part 34a. However, the present invention is not limited to this case and may be applied to a case where the wire harness W is inserted in a space formed by the inner surface of the net 34 and the extra length part 34.

Further, in the illustrative embodiments 4 and 5, the resin hooks 350, 350 are hung on the left and right side members 32a, 32b of the wire 32. However, the present invention is not limited to this case and may be applied to a case where the resin hooks 350, 350 are hung on the left and right side frames 12, 14 of the cushion frame 10. In this case, the wire 32 may be omitted.

Further, in the illustrative embodiment 5, the wire harness W is inserted in the clip 40 and the clip 40 is inserted and engaged in the resin bracket 450. However, the present invention is not limited to this case and may be applied to a case where the wire harness W is directly hung on the resin bracket 450 without using the clip 40. In this case, the resin bracket 450 may be an example of a clip.

What is claimed is:

1. A vehicle seat comprising:
a pad support which includes a net for supporting a cushion pad; and
a wire harness which is wired while being hung on the net via a clip attached to the net in a state of not causing a foreign-body feeling to a seated person.

2. The vehicle seat according to claim 1,
wherein the pad support further includes a wire formed in a substantially rectangular shape,
wherein the net is stretched over the wire to have an extra length part, and
wherein the wire harness is wired while being hung on the extra length part of the net.

3. A vehicle seat comprising:
a pad support which includes a wire formed in a substantially rectangular shape and a net for supporting a cushion pad, the net including a stretched portion which is stretched over the wire in a stretched state, and an extra length part which extends from the stretched portion; and
a wire harness which is wired while being hung on the extra length part of the net via a clip.

4. The vehicle seat according to claim 3,
wherein the extra length part is formed with a hole, and the clip is inserted in the hole.

5. The vehicle seat according to claim 4,
wherein a tip end of the extra length part is attached to a side of the net opposite to a side of supporting the cushion pad.

6. The vehicle seat according to claim 3,
wherein the clip is sewn to the extra length part.
